(19) United States
(12) Patent Application Publication
(10) Pub. No.: US 2008/0267734 A1
(43) Pub. Date: Oct. 30, 2008

(54) BOOKBINDING APPARATUS AND IMAGE FORMING SYSTEM

(75) Inventor: Masahiro KANEKO, Tokyo (JP)

Correspondence Address: FRISHAUF, HOLTZ, GOODMAN & CHICK, PC, 220 Fifth Avenue, 16TH Floor, NEW YORK, NY, 10001-7708, US

(73) Assignee: Konica Minolta Business Technologies, Inc., Tokyo (JP)

(21) Appl. No.: 12/047,559

(22) Filed: Mar. 13, 2008

(30) Foreign Application Priority Data
Apr. 27, 2007 (JP) JP2007-118449

(51) Int. Cl. B42C 13/00

(52) U.S. Cl. 412/13; 412/37; 412/9

(57) ABSTRACT

A bookbinding apparatus having: a coating device for coating adhesive onto a spine of a sheet bundle; a first moving device which moves the coating device along the spine of the sheet bundle; a second moving device which moves the coating device in a substantially perpendicular direction to a surface of the spine; and a control device, wherein the control device controls the first moving device to move the coating device along the spine from near a one corner of the spine of the sheet bundle toward another corner until the coating device reaches to near the another corner of the spine of the sheet bundle, then controls the second moving device to separate the coating device away from the spine of the sheet bundle and keeps the coating device for a predetermined duration after separating

### RELATED APPLICATION

This application is based on Japanese Patent Application NO. 2007-118449 filed on Apr. 27, 2007 in Japan Patent Office, the entire content of which is hereby incorporated by reference.

### TECHNICAL FIELD

This invention relates to a bookbinding apparatus and an image forming system having the bookbinding apparatus, particularly relates to an art for making a booklet by adhearing a plurality of sheets with adhesive.

### BACKGROUND OF THE INVENTION

In the field of a light production, the image forming system, which performs from printing to bookbinding and creates a booklet, has widely spread by connecting a bookbinding apparatus and the image forming apparatus having high-speed image formation performance, like, for example, an electro photography image forming apparatus.

According to the conventional and general bookbinding process, a printing process and a bookbinding process are respectively executed as separate processes in such image forming system On the other hand, although printing speed and the bookbinding speed itself are low, it has the advantage that the contents of printing can be changed at any time, and synthetically, it is an efficient image forming system and is used as a POD (PRINT ON DEMAND) system.

A feature of the POD system is that it is very flexible such that the contents of printing can be changed at any time according to a customer's request. Therefore, in the POD system, the booklets, from a several tens page booklet to the booklet of hundreds pages, which cover a large area and have different thicknesses, are created. The POD system can also handle various kinds of sheets.

On the other hand, since in many cases, the POD system is installed in an office environment, a small size design is required.

For this reason, in the bookbinding apparatus, which configures the system, a comparatively simple binding process is needed and the process of binding sheets using adhesives is used.

With respect to such bookbinding apparatus, a bookbinding apparatus disclosed in Unexamined Japanese Patent Application Publication No. 2004-209744 has been known.

According to the bookbinding apparatus disclosed in Unexamined Japanese Patent Application Publication No. 2004-209744, adhesives are applied along the spine of a sheet bundle in the longitudinal direction by a coating roller, which moves back and forth, and the coating amount corresponding to the thickness of the booklet is controlled by the bookbinding apparatus by the selection of the rotation direction of the coating roller.

According to the conventional method for forming a booklet by coating the adhesive onto the spine of the sheet bundle, it is known that there is a problem that in case when the thickness of the coated adhesive is thin, the adhesive will break when opening the formed booklet.

Further, when separating the coating roller from the sheet bundle at the end of coating of the adhesive, the thickness of adhesive partially became thick and became a convex shape facing downward. When the coating thickness of the adhesives was thickened, the convex section becomes a drop and drips befouling the inside of an apparatus, and the convex section may have become a drop, and may befoul the inside of the apparatus.

Since the inside of the apparatus has to be cleaned in the event that the drop and the thread of the adhesives have adhered in the apparatus, there had been a problem, which causes the increase in a maintenance man hour and the decline of productivity. When not maintained, there was a problem that the thread of the adhesives might adhere to the sheet bundle.

It becomes possible to coat adhesives uniformly by the bookbinding apparatus disclosed in the patent reference No. 1 by carrying out back and forth movement of the coating roller along the spine of the sheet bundle, coating adhesives, and stopping the coating roller after double action. However, the problem that the adhesives mentioned above become a drop shape or a thread shape has not been fully described, and the explanation of the concrete the stop position of the coating roller does not have described.

### SUMMARY OF THE INVENTION

One aspect of the present invention is a bookbinding apparatus comprising:

a coating device for coating adhesive onto a spine of a sheet bundle;

a first moving device which moves the coating device along the spine of the sheet bundle;

a second moving device which contacts and separates the coating device against and away from the spine of the sheet bundle in a substantially perpendicular direction to a surface of the spine; and

a control device which controls the first moving device, the second moving device and the coating device,

wherein the control device controls the first moving device to move the coating device along the spine from near a one corner of the spine of the sheet bundle toward another corner until the coating device reaches to near the another corner of the spine of the sheet bundle, then controls the second moving device to separate the coating device away from the spine of the sheet bundle and keeps the coating device for a predetermined duration after separating.

Another aspect of the present invention is a bookbinding apparatus comprising:

a coating device which coats adhesive onto a spine of a sheet bundle,

a first moving device which moves the coating device along the spine of the sheet bundle,

a second moving device which contacts and separates the coating device against and away from the spine of the sheet bundle in a substantially perpendicular direction toward a surface of the spine; and

a control device which controls the first moving device, the second moving method and the coating device,

wherein the coating device comprises an adhesive tub which accommodates an adhesive, and a coating roller for supplying the adhesive in the adhesive tub onto the spine of the sheet bundle, and

wherein the control device controls the first moving device to move the coating device along the spine from near a one corner of the spine of the sheet bundle toward another corner until the coating device reaches to near the another corner of the spine of the sheet bundle,

then controls the second moving device to separate the coating device away from the spine of the sheet bundle,

further controls the first moving device to move the coating device until a plumb which passes near the another corner of the spine is located in a zone from an inner side of a corner of the adhesive tub to a peripheral surface of the coating roller and keeps the coating device for a predetermined duration.

### BRIEF DESCRIPTION OF THE DRAWINGS

FIG. 1 illustrates an entire image forming system provided with a bookbinding apparatus pertaining to an embodiment of the present invention.

FIG. 2 illustrates an entire coating apparatus.

FIG. 3 illustrates a detailed structure of a coating apparatus 60.

FIG. 4 illustrates an explanatory view of a stop position near the lower streamside in the longitudinal direction corner section SSB of coating device 61.

FIG. 5 illustrates a block diagram of an image forming system, which has a bookbinding apparatus and an image forming apparatus.

FIG. 6 illustrates a flow chart of a coating processing control of adhesives of the bookbinding apparatus.

FIG. 7 illustrates a second flowchart of a coating processing control of the adhesives of the bookbinding apparatus.

FIG. 8 illustrates a flowchart of a coating processing control of the adhesives according to the sheet size of the bookbinding apparatus.

FIG. 9 illustrates an explanatory view of lower streamside stop position information table TE1, which has memorized the lower streamside stop position information on the coating device 61 corresponding to various kinds of sheet sizes.

### PREFERRED EMBODIMENT OF THE INVENTION

Although the embodiment of illustration explains the present invention, the present invention is not limited to this embodiment.

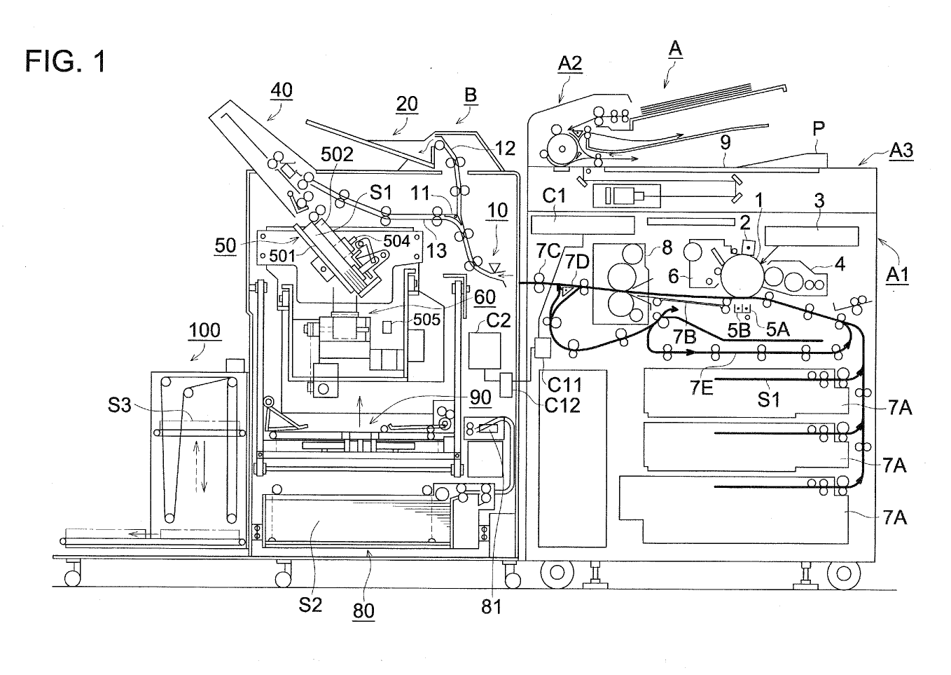

FIG. 1 illustrates the entire image forming system provided with a bookbinding apparatus concerning an embodiment of the present invention.

An image forming system has an image forming apparatus A for recoding an image onto a sheet, and a bookbinding apparatus B, which carries out bookbinding processing of the sheet onto which the image has been recorded by the image forming apparatus A.

The image forming apparatus A forms an image onto a sheet with an electro photography method, and has an image forming section A1, a document conveyance apparatus A2 and an image reading section A3.

In the image forming section A1, a charging device 2, an exposure device 3, a development device 4, a transfer device 5A, a separation device 5B, and a cleaning device 6 are arranged around a drum-like photo conductor 1. Charging, exposure, development, and transfer are performed by such electro photographic processing devices. A toner image is formed onto the photo conductor 1, and an image is formed onto a sheet S1.

The sheet S1 is stored in three sheet feed trays 7A's. The sheet S1 is sheet-fed from these sheet feed trays 7A one sheet at a time, and the toner image on the photo conductor 1 is transferred onto the sheet S1 by the transfer device 5A.

The toner image transferred onto the sheet Si passes through a fixing device 8, and fixing processing is carried out. The sheet S1 onto which fixing processing was carried out is sheet-ejected from the ejection rollers 7C, or conveyed onto a sheet re-feeding path 7E.

In the facedown sheet ejection in a one-side print, in the face-up sheet ejection in a one-side print, or in the surface image formation in double-sided image formation, a switching gate 7D changes and guides the sheet S1. That is, in the face-up sheet ejection, the switching gate 7D allows the sheet S1 to go straight on, and in the facedown sheet ejection and the double-sided image formation, the switching gate 7D guides the sheet S1 downward.

In the facedown sheet ejection, after the sheet Si is guided downward, it is switch backed, and is conveyed upward and is sheet-ejected from the ejection rollers 7C.

In the double-sided image formation, sheet S1 is guided downward, and passes through sheet re-feeding path 7E after surface inversion by switchback. The sheet Si is sheet-re-fed to the transfer section by which the transfer device 5A has been arranged, and transfer of a back surface image is performed.

The document conveyance apparatus A2 conveys one document at a time into a reading position The image reading section A3 reads the image of the document conveyed by document conveyance apparatus A2 or the document placed on the document table 9, and generates an image signal.

An image forming apparatus control device C1 controls the operation related to the image forming apparatus A mentioned above.

The bookbinding apparatus B is an apparatus configures a sheet bundle by bundling a plurality of sheets S1 sent in from the image forming apparatus A, and forms a booklet (book) by joining a cover sheet to this sheet bundle.

Hereafter, the cover sheet is called a sheet cover S2 and the bundle of sheet Si to which the cover sheet S2 is joined is called a booklet S3.

The bookbinding apparatus B includes a conveyance section 10 for conveying a sheet S1 sheet-ejected from the image forming apparatus A to a sheet ejection tray 20 or a sheet reversing section 40, an sheet ejection tray 20, a sheet reversing section 40, a accumulation section 50 for accumulating the sheet S1 sent in one by one or several sheets at a time, a coating apparatus 60, a cover sheet storage section 80 for storing the cover sheet S2, a cover sheet support section 90for supporting a cover sheet, and a booklet ejection section 100 for accumulating booklets.

The sheet S1 ejected from the image forming apparatus A is ejected through an ejection path 12 to a sheet ejection tray 20 by the switching gate 11 provided via the conveyance section 10, or is conveyed by to the sheet reversing section 40. In the event that it is not in a bookbinding processing mode, the sheet S1 is ejected to the ejection tray 20.

In a bookbinding mode, the sheet S1 is conveyed to the sheet reversing section 40 through a conveyance path 13, and after the sheet S1 is switch backed at the sheet reversing section 40, the sheet S1 is conveyed to the accumulation section 50.

In the accumulation section 50, a set number of the sheet S1 is accumulated, the accumulated sheet is nipped and rotated between a sheet accumulation board 501 and a sheet nipping board 502, and holds the bundle of the sheet S1 in a substantially perpendicular state.

A thickness measurement sensor 504 for measuring the thickness of the bundle of the sheet S1 nipped between the collection board 501 and the sheet nipping board 502 is disposed in the sheet nipping board 502, and when sheet nipping board 502 nips the bundle of the sheet S1, onto which load has been supplied toward the collection board 501, measures the thickness of the nipped bundle of the sheet S1.

An operator may calculate the thickness of a sheet bundle based on the number of sheets and the paper type of a sheet, which configure the booklet, set up by an operation panel P of the image forming apparatus A instead of measuring the thickness of the sheet bundle by the sensor.

And the adhesives are coated onto the undersurface of the bundle of the sheet S1 nipped in the perpendicular state by the coating apparatus 60. A hot melt, which is easy handling, solidifies by cooling for a short time, and is maintaining flexibility after solidification, is suitable for the adhesives.

The cover sheet S2 sheet-fed from the cover sheet storage section 80 contacts and adheres to the bundle of sheet S1 to which the adhesives have been coated.

The booklet S3 formed by adhering the cover sheet S2 to the bundle of sheet S1 is ejected by the booklet ejection section 100.

A bookbinding control device C2 controls the above-mentioned operation related to the bookbinding apparatus B, and the operation related to the coating apparatus 60 described later.

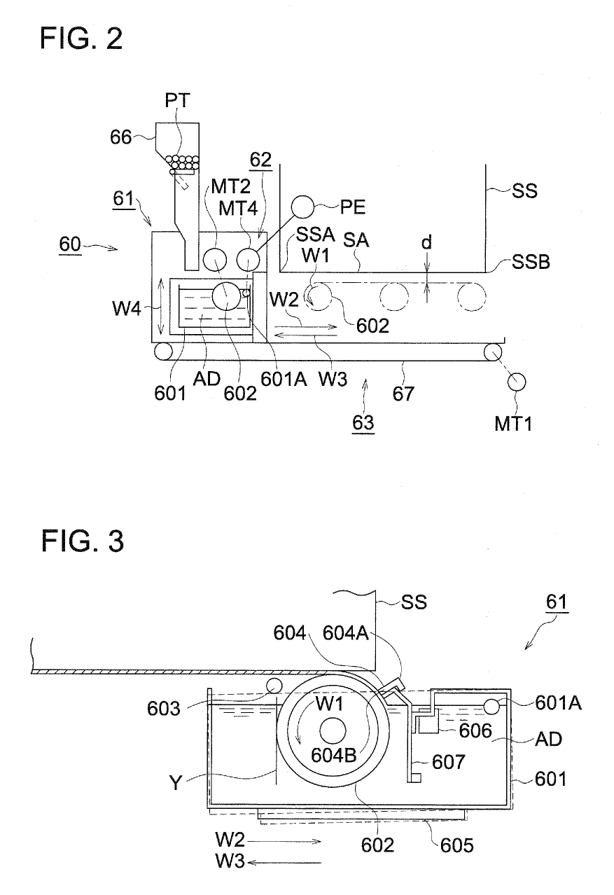

FIG. 2 illustrates the entire coating apparatus.

The coating apparatus 60 is configured by a coating device 61, which is arranged under a sheet bundle SS and coats adhesive AD to the spine of the sheet bundle SS, a gap increasing and decreasing device 62 (herein after the second moving device is described as the gap increasing and decreasing device 62), which is the second moving device for changing the gap between the adhesives coating side of the coating device 61 and the spine of the sheet bundle, and a parallel moving device 63 (hereinafter the first moving device is described as the parallel moving device 63), which is the first moving device for moving the coating device 61 along the spine of the sheet bundle SS.

The coating device 61 includes an adhesives tub 601, which contains adhesives AD, and a coating roller 602, which coats the adhesives AD to the spine of the sheet bundle SS.

The gap increasing and decreasing device 62 includes a motor MT4 for swinging the coating device 61 centering on an axis 601A, and for changing a gap “d” between the adhesives coating side of the coating roller 602 and the spine of the sheet bundle SS.

The parallel moving device 63 includes a motor MT1 for moving the coating device 61 in parallel along the spine SA of the sheet bundle SS via a drive belt 67.

The coating device 61 is capable of moving in the up-and-down direction (the direction of an arrow W4) and to the horizontal direction (the direction of arrows W2/W3) against the sheet bundle SS in the drawing.

The up-and-down movement of the direction of the arrow W4 is performed by the reciprocal rotation drive of the motor MT4, which allows the coating device 61 to swing centering on the axis 601A. And the gap “d” in between the surface (opposed position with spine SA) of the coating roller 602 and the spine SA is increased and decreased by this up-and-down movement.

The forward movement illustrated by the arrow W2 and the backward movement illustrated by the arrow W3 are performed by the reciprocal rotation drive of motor MT1, which reciprocally moves the coating device 61 via the drive belt 67. And at the time of the forward movement illustrated by the arrow W2, the coating roller 602 coats the adhesives AD to the spine SA of the sheet bundle SS, and the coating roller 602 coats the adhesives AD to the spine SA also at the time of the backward movement illustrated by the arrow W3.

However, the adhesives AD may be coated only at the time of either of the reciprocation.

The home position of the coating device 61 is the left end position of the drawing, which is away from the sheet bundle SS in the direction of arrow w2/w3, and is located at the back side when viewing from the front of the bookbinding apparatus B in FIG. 1. The surface (opposed position with spine SA) of the coating roller 6C2 and the spine SA are estranged in the arrow W4 direction, therefore the coating of the adhesives is not performed.

And at the home position of the coating device 61, a pellet PT of the adhesives is supplied from a supply apparatus 66.

FIG. 3 illustrates a detailed structure of the coating apparatus 60.

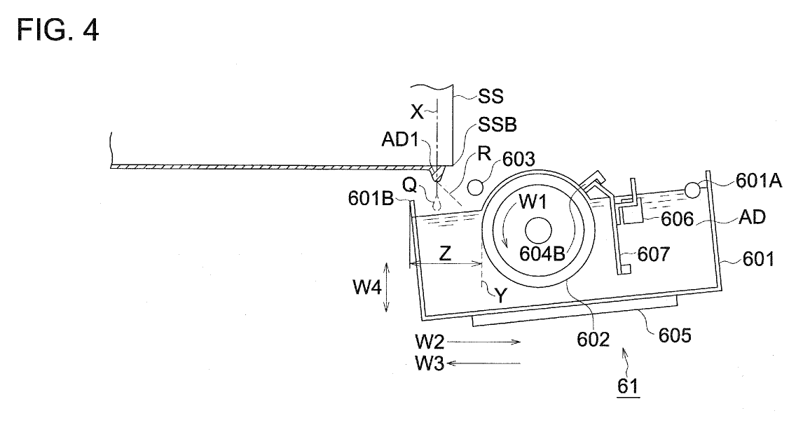

Hereinafter, the coating of the adhesives at the time of the forward movement and the backward movement of the coating roller 602 will be explained in detail in reference to FIG. 2, FIG. 3, and FIG. 4.

In the following explanation, the upper streamside refers to the upper streamside at the time of the forward movement of the coating device 61, and the lower streamside refers to the lower streamside at the time of the forward movement of the coating device 61.

The forward movement indicates the operation towards the lower stream from the upper stream, and the backward movement indicates the operation towards the upper stream from the lower stream.

The coating apparatus 60, in addition to the above-mentioned, includes regulating members 603 and 604, a heater 605, and an adhesive amount sensor 606.

A pellet in the adhesives tub 601 is heated by the heater and melts to form the coating liquid of the adhesives AD. However, the amount of the adhesives AD is detected by the adhesives amount sensor 606, which consists of a temperature sensor, and a surface of the liquid is maintained uniformly. The regulating member 604 is supported by a plate-shaped support member 607. The regulating member 604 regulates the layer thickness of the adhesives on the coating roller 602 with the lower end corner 604B, and regulates the layer thickness of the adhesives on the spine SA of the sheet bundle with the upper end corner 604A.

The regulating member 603 of the coating roller located in the upper stream side of the coating roller 602 regulates the thickness of the coating layer when the coating device 61 conducts coating by moving in the direction illustrated by the arrow W2. A regulation section 604A of the regulating member 604 located in the lower stream side of the coating roller 602 regulates the thickness of a coating layer when the coating device 61 conducts coating by moving in the direction illustrated by the arrow W3.

The coating roller 602 is rotated in the direction illustrated by the arrow WI by the drive of motor MT2. Further, the coating roller 602 pumps up the adhesives AD from the adhesive tub 601, and allows the adhesives AD to be coated onto the spine SA of the sheet bundle SS.

When the bundle of the sheet S1 is held in a substantially perpendicular state at the accumulation section 50, the movement of the coating device 61 located in the home position (the left end position in the figure) of the direction of the arrows W2/W3 is started by a normal rotation of the motor MT1 towards the lower stream side (the arrow W 2 direction) via the drive belt 67.

When the coating roller 602 of the coating device 61 comes to near one corner, namely, near the longitudinal direction corner SSA at the upper stream side of the sheet bundle SS, the coating device 61 rises towards the sheet bundle SS by the normal rotation of the motor MT4, and when the gap “d” between the spine SA of the sheet bundle SS and the surface (opposed position with the spine SA) of the coating the roller 602 becomes a value equaled to the adhesives coating thickness set up in advance, the coating device 61 stops.

The one corner of the sheet bundle indicates the coating direction upstream side corner of the sheet bundle in the forward movement, and near the one corner indicates the position of 0-15 mm inside (to the lower stream side), preferably 3-5 mm, from the coating direction upstream side corner. When shorter than this, the adhesives may overflow from the sheet corner, and the adhesion of the corner may become weak when longer than this.

The another corner of the sheet bundle Indicates the coating direction lower stream side corner of the sheet bundle in the forward movement, and near the another corner indicates the position of 0-5 mm inside (to the upper stream side), preferably 3-5 mm, from the coating direction lower stream side corner. When shorter than this, the adhesives may overflow from the sheet corner, and the adhesion of the corner may become weak when longer than this.

FIG. 4 illustrates an explanatory view of the stop position near the lower streamside longitudinal direction corner SSB of the coating device 61.

The explanation of the same reference characters as FIG. 3 will be omitted.

When the coating roller 602 of the coating device 61 comes to near the another corner, namely, near the longitudinal direction corner SSB of the lower stream side of the sheet bundle SS, the coating device 61 will descend in the direction estranged from the sheet bundle SS by the reversal of the motor MT4, and the coating device 61 will stop it in a lower end.

Since the adhesives AD coated onto the booklet bundle SS are still in molten state, the adhesives AD coated onto the booklet bundle SS are pulled by the coating roller 602 by the adhesive power at the time of the descent of the coating device 61, and just before breaking off, the adhesives AD form a convex section AD1.

And before reaching to an open time, since the adhesives AD forming the convex section AD1 is in molten state, the adhesives AD may become a drop Q by the gravity, or may pull thread R.

Since conventionally the corner 601B in the upper stream side of the adhesive tub 601 was located and stopped in further lower stream side from the longitudinal direction corner SSB in the lower stream side of the sheet bundle SS, the drop Q and the thread R, which fall from the convex section AD1, did not enter into adhesive tub 601. Therefore, the drop Q and the thread R fell and befouled the vicinity of the coating apparatus 60.

Therefore, present invention is for not to befouling inside of an apparatus by dropping the generated drop and thread of adhesives into the adhesive tub 601, and melting them.

In a first embodiment, the motor MT1 is rotated in a forward direction and the coating device 61 is moved from longitudinal direction corner SSA in the upper streamside to the longitudinal direction corner SSE in the lower streamside along the spine SA of the sheet bundle. The motor MT4 is rotated in the backward direction to estrange the coating device 61 from the spine SA of the sheet bundle after the movement, and after the estrangement, the motor MT1 and the motor M4 are stopped for a predetermined duration to stop the coating device 61 for the predetermined time.

And, after a predetermined time stop, the motor MT4 is rotated in the forward direction and the coating device 61 is moved toward the spine SA of the sheet bundle. After the movement, the motor MT1 is rotated in the backward direction and the coating device 61 is moved along the spine SA of the sheet bundle to near the longitudinal direction corner SSA in the upper streamside.

In a second embodiment, the motor MT1 is rotated in the forward direction and the coating device 61 is moved from the longitudinal direction corner SSA in the upper streamside to near the longitudinal direction corner SSE in the lower streamside along spine SA of a sheet bundle. Then, after the movement, the motor MT4 is rotated in the backward direction to estrange the coating device 61 from the spine SA of the sheet bundle. Based on this operation, the motor MT1 is rotated in the forward direction and the coating device 61 is moved so that the plumb line X (a dashed dotted line) near the longitudinal direction corner SSB in the lower stream side may be located in the zone Z included in the inner side of the corner 601B of the adhesive tub 601 of the coating device 61, and the upper stream side of upper stream side vertical plane Y of the peripheral surface of the coating roller 602. After that, the predetermined time stop of the coating device 61 is carried out by the stop of the motor MT1 and the motor MT4.

And after a predetermined time stop, the motor MT1 is rotated in the forward direction and the coating device 61 is moved to near the longitudinal direction corner SSB in the lower streamside. After that, the motor MT4 is rotated in the forward direction and the coating device 61 is moved toward the spine SA of the sheet bundle. After the movement, the motor MT1 is rotated in the backward direction and the coating device 61 is moved along the spine SA of the sheet bundle to near the longitudinal direction corner SSA in the upper streamside.

Here, in the first and the second embodiments, after the coating device 61 is moved to near the longitudinal direction corner SSA in the upper stream side, it is further preferable to rotate the motor MT4 in the backward direction to estrange the coating device 61 from the spine SA of the sheet bundle, and to stop the coating device 61 for the predetermined time as mentioned above.

The predetermined time for which the coating device 61 is stopped is obtained by experimenting the duration for which the adhesives AD, which forms a convex section AD1, becomes a drop and will certainly not fall and the duration for which the adhesives AD will not pull thread and by selecting whichever 45 longer. This duration is memorized into a memory device and read out when it is needed.

The time will be changed by the used adhesives, ambient temperature and the temperature of melted adhesives. However, for example, it is preferable to set the time at not less than 0.5 second and not more than the open time of the adhesives.

The following procedures may be used. The motor MT1 is rotated in the forward direction and the coating device 61 is moved from near the longitudinal direction corner SSA in the upper streamside to near the longitudinal direction corner SSB in the lower streamside along the spine SA of the sheet bundle. While rotating the motor MT4 in the backward direction and estranging the coating device 61 from the spine SA of the sheet bundle after the movement, at the same time, the motor MT1 is rotated in the forward direction and the coating device 61 is moved so that the plumb line X (dashed dotted line) near the longitudinal direction corner SSB in the lower stream side is located in zone Z, which is included inside the corner 601B of the adhesive tub 601 of the coating device 61, and upper stream side of the upper stream side vertical plane Y of the peripheral surface of the coating roller 602. After that, the predetermined time stop of the motor MT1 and the motor MT4 is carried out and the predetermined time stop of the coating device 61 is carried out.

Explained was an embodiment, which rotates the motor MT1 in the forward direction and the coating device 61 is moved from near the longitudinal direction corner SSA in the upper stream side to near the longitudinal direction corner SSB in the lower stream side along the spine SA of the sheet bundle, and rotates the motor MT4 in the backward direction to estrange the coating device 61 from the spine SA of the sheet bundle after the movement. However, the motor MT1 may be rotated in the forward direction and the coating device 61 may be moved to the longitudinal direction corner SSB in the lower stream side or the position, which exceeds longitudinal direction corner SSB in the lower stream side, along the spine SA of the sheet bundle from near the longitudinal direction corner SSA in the upper stream side. And after the movement, the motor MT4 may be rotated in the backward direction to estrange the coating device 51 from the spine SA of the sheet bundle.

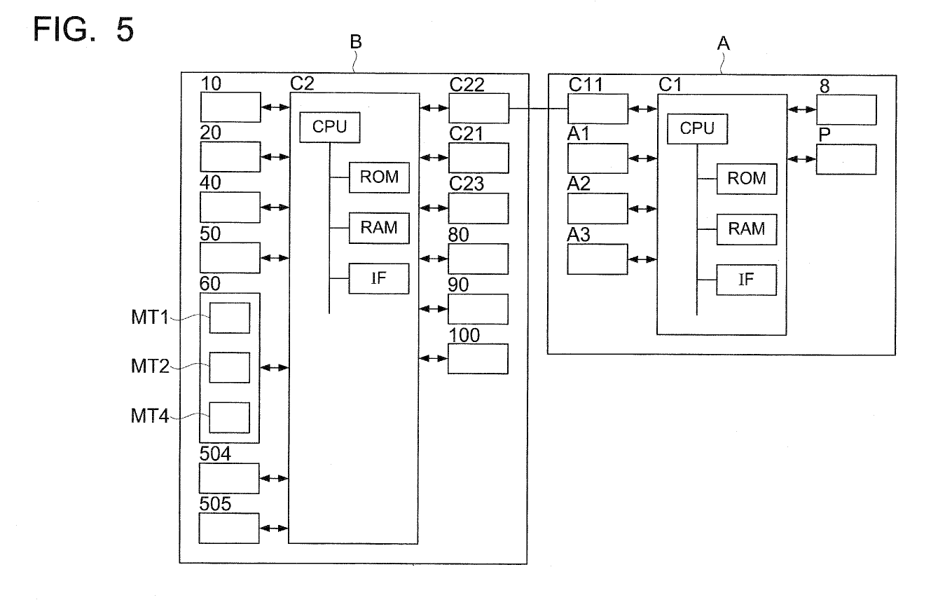

FIG. 5 illustrates a block diagram of an image forming system, which has a bookbinding apparatus and an image forming apparatus.

The image forming system includes the image forming apparatus A and the bookbinding apparatus B.

The image forming apparatus control device C1, which controls the image forming apparatus A, and the bookbinding control device C2, which controls the bookbinding apparatus B, respectively include a CPU (Central Processing Unit), a ROM (Read Only Memory), a nonvolatile RAM (Random Access Memory) (for example, a RAM backed up by a battery) and an IF (interface) for interfacing with various apparatuses, which will be described below.

An image forming communication device C11 is controlled by the image forming apparatus control device C1, and performs a serial communication with a bookbinding apparatus communication device C22 of the bookbinding apparatus B.

The document conveyance apparatus A2 is controlled by the image forming apparatus control device C1. The document conveyance apparatus A2 conveys a document to the image reading section of the image reading section A3.

The image reading section A3 is controlled by the image forming apparatus control device C1, reads the image of the document conveyed by the document conveyance apparatus A2, and inputs document image information into the image forming apparatus control device C1.

The image forming section A1 is controlled by the image forming apparatus control device C1, and, for example, forms an image onto a sheet based on the document image information inputted by the image reading section A3.

A fixing device 8 is controlled by the image forming apparatus control device C1, and is fixed by carrying out heat sticking of the toner image formed on the sheet by the image forming section A1.

An operation panel P has a touch panel and is controlled by image forming apparatus control device C1. The information related to various operation switches or bookbinding processing are displayed on a touch panel, and the operation information on various operation switches is inputted into the image forming apparatus control device C1.

A bookbinding apparatus communication device C22 is controlled by a bookbinding control device C2, and performs serial communication with the image forming communication device C11 of the image forming apparatus A.

A conveyance section 10 is controlled by the bookbinding control device C2, and conveys the ejected sheet S1 from the image forming apparatus A to a sheet ejection tray 20 or a sheet reversing section 40.

The sheet ejection tray 20 is controlled by the bookbinding control device C2, and accumulates the sheet S1 conveyed from the conveyance section 10.

The sheet reversing section 40 is controlled by the bookbinding control device C2, reverses (switchback) the sheet S1 conveyed from the conveyance section 10, and sheet feeds it to an accumulation section 50.

The accumulation section 50 is controlled by the bookbinding control device C2, and accumulates predetermined number-of-sheets of the sheet S1 conveyed from conveyance section 10.

The coating apparatus 60 is controlled by the bookbinding control device C2, and coats adhesives to the spine of the sheet bundle accumulated by the accumulation section 50.

A pulse motor is preferred for the motor MT1 of the coating apparatus 60, and the motor MT1 moves the coating device 61 along the spine of the sheet bundle. And the bookbinding control device C2 counts the drive pulse of the motor MT1, calculates the movement amount of the coating device 61 in the direction of the arrows W2/W3, and grasps the position of the coating device 61.

The movement amount of the direction of the arrows W2/W3 of the coating device 61 may be grasped by counting the pulse of the pulse encoder, which is connected to the motor MT1, by providing a counter C21, which is controlled by bookbinding control device C2.

A motor MT2 of the coating apparatus 60 rotates the coating roller 602.

A pulse motor is preferred for the motor MT4 of the coating apparatus 60, and the motor MT4 moves the coating device 61 perpendicularly to the spine of the sheet bundle. And the bookbinding control device C2 counts the drive pulse of the motor MT4, calculates the movement amount in the arrow W4 direction of the coating device 61, and grasps the position of the coating device 61.

The pulse of the pulse encoder PE connected to motor MT4 may be arranged to be counted by providing the counter C21 controlled by the bookbinding control device C2 to grasp the movement amount of the coating device 61 in the arrow W4 direction.

A thickness measurement sensor 504 is controlled by the bookbinding control device C2. The thickness measurement sensor 504 measures the thickness of nipped sheet bundle nipped by the accumulation section 50, and inputs measured value into the bookbinding control device C2.

An environmental temperature sensor 505 is controlled by the bookbinding control device C2. The environmental temperature sensor 505 measures the temperature near the accumulation section 50, and inputs measured value into the bookbinding control device C2.

A timer C23 is controlled by the bookbinding control device C2. The timer C23 measures the stop duration of the coating device 61, and inputs the stop duration into the bookbinding control device C2.

A cover sheet storage section 80 is controlled by the bookbinding control device C2. The cover sheet storage section 80 sheet-feeds the cover sheet stored if needed.

A cover sheet support section 90 is controlled by the bookbinding control device C2. The cover sheet support section 90 adheres the cover sheet onto the spine of the sheet bundle by supporting the cover sheet, which was sheet-fed.

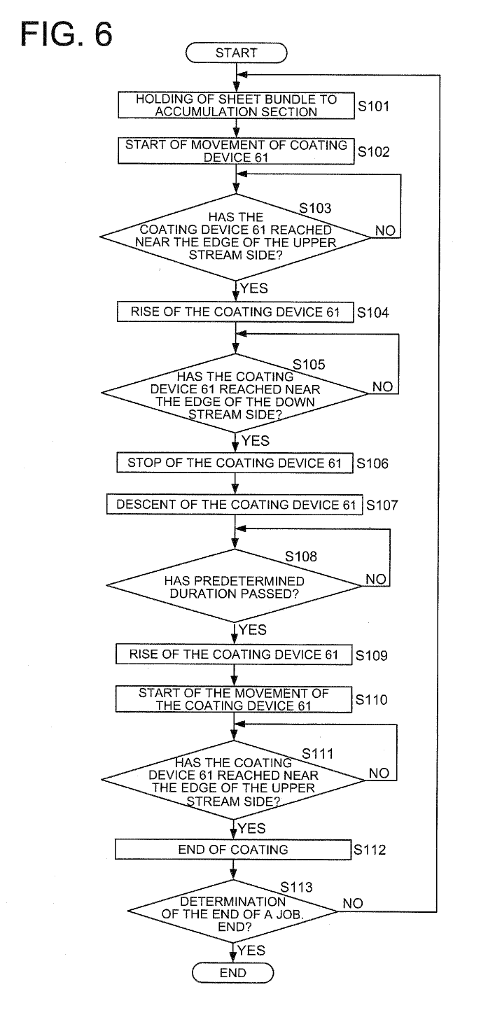

The booklet ejection section 100 is controlled by the bookbinding control device C2. The booklet ejection section 100 accumulates the completed booklet. FIG. 6 illustrates a flow chart of a coating processing control of the adhesives of the bookbinding apparatus.

Explanation will be conducted based on the assumption that the coating device 61 is positioned at the home position during image formation (under continuation sheet feeding).

1. Holding of sheet bundle to the accumulation section (STEP S101): When the set number of sheets of sheet S1 have been accumulated at the accumulation section 50, the accumulated sheets will be nipped between the sheet accumulation board 501 and the sheet nipping board 502, and will be rotated to hold the bundle of sheet Si in a substantially perpendicular states. Then, proceeds to the following step.

And the thickness of the nipped bundle of sheet S1 is measured by the thickness measurement sensor 504 The RAM memorizes the measured value.

2. Start of movement of the coating device 61 (STEP S102): The coating device 61 is started to move toward the lower streamside (W 2 direction) via the drive belt 67 by the forward rotation of the motor MT1. Then proceeds to the next step.

3. The coating device 61 conducts determination of arrival to near the corner of the upper stream side (STEP S103): The movement is continued, and when the coating roller 602 of the coating device 61 reaches near the longitudinal direction corner SSA in the upper stream side (Yes), the process proceeds to the next step and STEP S103 is repeated until the coating device 61 reaches to the longitudinal direction corner SSA (No).

Here, the movement of the coating device 61 in the W2/W3 direction becomes possible by stopping the movement by having the counter C21 count the drive pulse of the motor MT1, converting the counted value to the movement value of the coating device 61, when the converted movement value becomes equal value to the predetermined distance, for example, the distance from the home position in the W2/W3 direction to near the longitudinal direction corner SSA in the upper stream side.

The output pulse of a pulse encoder connected to the motor MT4 may be counted by the counter C21 and the counted value may be converted to the movement amount of the coating device 61.

4. The rise of the coating device 61 (STEP 104): After the coating device 61 has reached near the longitudinal direction corner SSA in the upper streamside, the coating device 61 is raised toward the booklet bundle SS by the forward rotation of the motor MT4. Then, when the gap “d” between the spine SA of the sheet bundle SS and the surface (opposed position with the spine SA) of the coating roller 602 becomes the equal value to the adhesives coating thickness, the coating device 61 is stopped. Then, proceeds to the next step.

Also during the rise, the movement is continued towards the lower streamside (W2 direction).

Here, the movement of the coating device 61 in the direction of W4 becomes possible by stopping the movement by having the counter C21 count the drive pulse of the motor MT4 and by converting the counted value to the converted movement value of the coating device 61, when the movement amount reaches to a value equal to a predetermined distance, for example, a distance from the home position of the coating device 61 in the W4 direction to the position where the coating roller 602 has reached to the point which is the gap “d” away from the spine SA.

The output pulse of the pulse encoder PE connected to the motor MT4 may be counted by the counter C21, and the count value may be converted into the movement amount of the coating device 61.

5. Determination of whether the coating device 61 has reached to near the corner of the down stream side (STEP S105): The coating roller 602 moves toward the lower stream side (W2 direction) while coating adhesive AZ onto the spine SA of the sheet bundle SS by the continuation of the forward rotation of the motor MT1. When the coating roller 602 of the coating device 61 has reached to near the longitudinal direction corner SSB in the lower stream side reaches (Yes), then it proceeds to the following STEP, STEP S105 is repeated until the coating device 61 reaches to near the corner in the lower stream side (No).

6. Stop of the coating device 61 (STEP S106): The movement toward the lower streamside (W2 direction) of the coating device 61 is stopped by the stop of the motor MT1 of the coating device 61 (STEP S106).

7. Descent of the coating device 61 (STEP S107): By reaching to near the longitudinal direction corner SSB in the lower stream side, the motor MT4 rotates in the backward direction, and the coating device 61 descends and stops, and proceeds to the following STEP.

8. Determination for continuation of stop for predetermined duration (STEP S108): A timer of a timer C23 is started by the stop of the descent of the coating device, When the time of the timer C23 is up after the predetermined duration (Yes), the process proceeds to the next step and STEP S209 is repeated until the time is up (No).

This stop time is memorized by memory device, such as the ROM, as described above, and is read out in this STEP.

Based on the above operation, even when the adhesives AD becomes a drop shape or drops while pulling threads, the drop or the thread will fall and melt in the adhesive tub 601. Therefore, the inside of the bookbinding apparatus B will not be befouled.

9. Rise of the coating device 61 (STEP S109): After stopping for a predetermined duration, the coating device 61 ascends toward the booklet bundle SS by the forward direction rotation of the motor MT4. When gap d between the spine SA of the sheet bundle SS and the surface (opposed position with the spine SA) of the coating roller 602 becomes a value equal to adhesives coating thickness, the coating device 61 is stopped, and the process proceeds to the following STEP.

10. Start of the movement of the coating device 61 (STEP S110): The movement of the coating device 61 towards the upper stream side (the direction of W3) via a drive belt 67 is started by the backward rotation of the motor MT1, and the process proceeds to the following STEP.

11. Determination of the coating device 61 reaching to near the corner of the upper stream (STEP S111): The coating roller 602 is moved toward the upper stream side (W3 direction) while coating the adhesive AZ onto the spine SA of the sheet bundle SS by the continuation of the backward rotation of the motor MT1. When the coating device 61 has reached to near the upper stream side corner (Yes), the process proceeds to the next step and the step S111 will be repeated until the coating device 611 reaches to the home position (No).

12. End of coating (STEP S112): Movement towards the upper streamside (W3 direction) of the coating device 61 is stopped by the stop of the motor MT1. And the coating device 61 is descended to the home position in the W4 direction by the backward rotation of the motor MT4 to finish the coating,

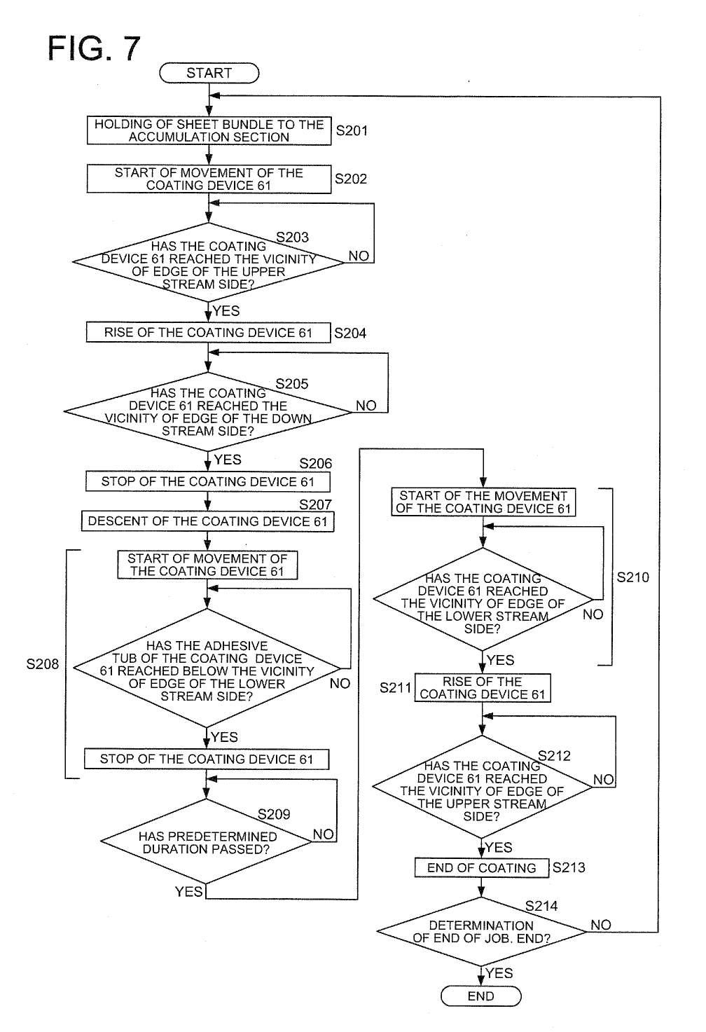

13. Determination of end of job (STEP S113): Based on the finish of the coating, the ending of job is determined. When the job has ended (Yes), the process proceeds to END. STEP S101-STEP S113 are repeated when the job has not ended (No), until the job is completed. FIG. 7 illustrates a second flowchart of the coating processing control of the adhesives of the bookbinding apparatus.

The flowchart of the second embodiment will be explained.

1. Holding of sheet bundle to accumulation section (STEP S201): Since it Is the same as that of STEP S101, explanation will be omitted.

2. Starting of movement of the coating device 61 (STEP S202): Since it is the same as that of STEP S102, explanation will be omitted.

3. Determination of the coating device 61 reaching to near the corner in the upper stream (STEP S203): Since it is the same as that of STEP S103, explanation will be omitted.

4. Rise of the coating device 61 (STEP S204): Since it is the same as that of STEP S104, explanation will be omitted.

5. Determination of whether the coating device 61 has reached to near the corner in the upper stream (STEP S205): Since it is the same as that of STEP S105, explanation will be omitted.

6. Stop of the coating device 61 (STEP S206): Since it is the same as that of STEP S106, explanation will be omitted.

7. Descent of the coating device 61 (STEP S207): Since it is the same as that of STEP S107, explanation will be omitted.

8. Determination of a reaching of the adhesive tub of the coating device 61 below near the corner (STEP S208): After descending, the coating device 61 is moved toward the lower streamside (W2 direction) by the forward rotation of the motor MT1. When the count value coincides with the drive pulse of the motor M1 corresponding to the distance where a plumb X passing through near longitudinal direction corner SSB in the lower stream side of the sheet bundle positions inside the zone Z included between the inside corner of the adhesive tank and an upper stream side plumb surface Y of the peripheral surface in the upper stream side of the coating roller 602 (Yes), the motor M1 is stopped, and the process moves to the next step. And, STEP S208 is repeated (No) until the drive pulse and the counted value become equal

9. Determination of a predetermined duration for continuation of descent (STEP S209): In accordance with the stop of the movement of the adhesive tub of the coating device 61 below near the corner of sheet bundle SS, a timer of a timer C23 is started. When the time of the timer C23 is up after the predetermined duration (Yes), the process proceeds to the next step and STEP S209 is repeated until the time is up (No).

This stop time is memorized by the memory device, such as the ROM, as described above, and is read out in this STEP.

Based on the above operation, even when the adhesives AD becomes a drop shape or drops while pulling threads, the drop or the thread will fall and melt in the adhesive tub 601. Therefore, the inside of the bookbinding apparatus B will not be befouled. Further, the adhesive AD will not fall on the coating roller. Thus, the fallen drops (lump of adhesive) on the coating roller do not generate partial coating unevenness.

10. Start of the movement of the coating device 61 (STEP S210): Same as STEP S110, the movement of the coating device 61 towards the upper stream side (the direction of W3) via a drive belt 67 is started by the backward rotation of the motor MT1, and when the coating roller 602 of the coating device 61 reaches near the longitudinal direction corner SSB in the lower stream side (Yes), the process proceeds to the next step and STEP S210 is repeated until the coating device 61 reaches to the longitudinal direction corner SSB (No)

11. Rise of the coating device 61 (STEP S211): Since it is the same as that of STEP S109, explanation will be omitted.

12. Determination of the coating device 61 reaching near the corner in the upper stream (STEP S212): Since it is the same as that of STEP S111, explanation will be omitted.

13. End of coating (STEP S213): Since it is the same as that of STEP S112, explanation will be omitted.

14. Determination of end of job (STEP S214): Since it is the same as that of STEP S113, explanation will be omitted.

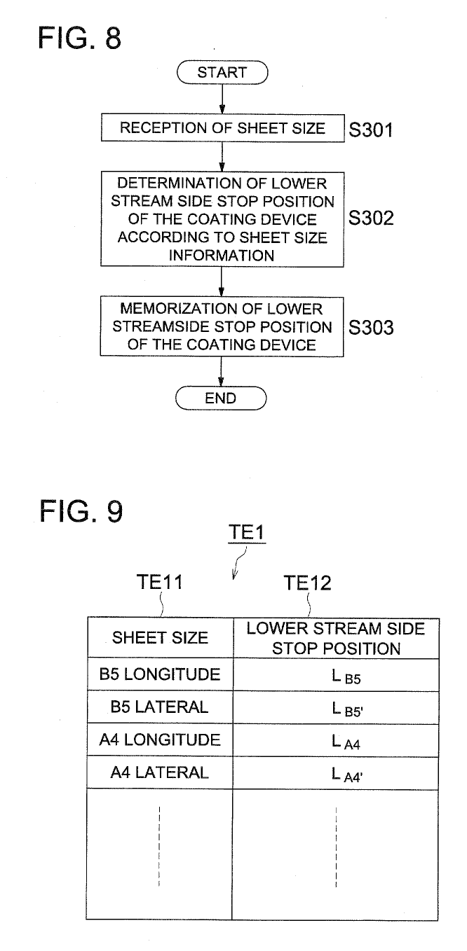

FIG. 8 illustrates a flowchart of a coating processing control of the adhesives according to the sheet size of the bookbinding apparatus.

FIG. 9 illustrates an explanatory view of lower streamside stop position information table TE1, which memorized the lower streamside stop position information on the coating device 61 corresponding to various kinds of sheet sizes.

The lower streamside stop position information table TE1 includes various kinds of sheet size column TE11 and a lower streamside stop position column TE12 storing the stop position of the coating device 61 corresponding to each sheet size.

For example, in the case of A4 size, it means to have the coating device stop in the position moved L_{A4} to the arrow W2 direction from the home position of the direction of the arrows W2/W3 of the coating device 61.

1. Reception of sheet size (STEP S301): When the sheet size (for example, A4) to which the adhesives are coated is received by the communication device C22 (serial communication) through a communication device C11 of the image forming apparatus A, which performs serial communication, the received sheet size (for example, A4 length) will be memorized into the RAM, and process proceeds to the following STEP.

2. Determination of lower streamside stop position of the coating device according to sheet size information (STEP S302): The lower streamside stop position information table TE1 is read from the ROM. The lower stream side stop position of the coating device corresponding to the sheet size (for example, A4 length) read from RAM among various kinds of sheet sizes memorized by the sheet size column TE11 will be searched from the lower stream side stop position column TE12 (for example, L_{A4}), the position (for example, L_{A4}) which the coating device 61 is supposed to stop is determined, and the process proceeds to the following STEP.

3. Memorization of upper streamside stop position of the coating device (STEP S303): The determined upper streamside stop position (for example, L_{A4}) of the coating device is memorized into the memory device, such as the RAM, and the process proceeds to END.

Here, in STEP S105 and STEP S205 described above, whether the coating device 61 has reached near the longitudinal direction corner SSB in the lower stream side of the sheet bundle SS is determined by determining that the coating device 61 has moved the distance from the home position in the W2/W3 direction to the predetermined upper stream side stop position of the coating device, for example, in a case of A4 length setup, whether the coating device has moved for the distance of L_{A4} is determined by converting the count value of the drive pulse of the motor MT1 into a distance.

What is claimed is:

1. A bookbinding apparatus comprising:
a coating device for coating adhesive onto a spine of a sheet bundle;
a first moving device which moves the coating device along the spine of the sheet bundle;
a second moving device which contacts and separates the coating device against and away from the spine of the sheet bundle in a substantially perpendicular direction to a surface of the spine; and
a control device which controls the first moving device, the second moving device and the coating device,
wherein the control device controls the first moving device to move the coating device along the spine from near one corner of the spine of the sheet bundle toward another corner until the coating device reaches to near the another corner of the spine of the sheet bundle, then controls the second moving device to separate the coating device away from the spine of the sheet bundle and keep the coating device for a predetermined duration after separating.

2. The bookbinding apparatus according to claim 1, wherein each near the one corner of the spine and near the another corner of spine is a position 0-15 mm inside from each corner.

3. The bookbinding apparatus according to claim 1, wherein the predetermined duration is not less than 0.5 second and not more than an open time of the adhesives.

4. The bookbinding apparatus according to claim 1, wherein the control device controls the first moving device to move the coating device from near the one corner to near the another corner along the spine based on setup sheet size information.

5. The bookbinding apparatus according to claim 1, wherein the control device controls the second moving device to move coating device toward the spine of the sheet bundle after the predetermined duration of keeping the coating device and then controls the first moving device to move the coating device to near the one corner from near the another corner along the spine.

6. The bookbinding apparatus according to claim 1, wherein the control device controls the second moving device to move the coating device toward the spine of the sheet bundle in the case when the coating device moves from near the one corner to near the another corner and in the case when the coating device moves from near the another corner to near the one corner, or in the case when the coating device moves from near the one corner to near the another corner.

7. An image forming system comprising an image forming apparatus for forming image on a sheet and the bookbinding apparatus according to claim 1 which binds sheet on which an image has been formed by the image forming apparatus into a booklet.

8. A bookbinding apparatus comprising:
a coating device which coats adhesive onto a spine of a sheet bundle,
a first moving device which moves the coating device along the spine of the sheet bundles
a second moving device which contacts and separates the coating device against and away from the spine of the sheet bundle in a substantially perpendicular direction toward a surface of the spine; and
a control device which controls the first moving device, the second moving device and the coating device,
wherein the coating device comprises an adhesive tub which accommodates an adhesive, and a coating roller for supplying the adhesive in the adhesive tub onto the spine of the sheet bundler and
wherein the control device controls the first moving device to move the coating device along the spine from near one corner of the spine of the sheet bundle toward another corner until the coating device reaches to near the another corner of the spine of the sheet bundle,
then controls the second moving device to separate the coating device away from the spine of the sheet bundle,
further controls the first moving device to move the coating device until a plumb which passes near the another corner of the spine is located in a zone from an inner side of a corner of the adhesive tub to a peripheral surface of the coating roller and keeps the coating device for a predetermined duration.

9. The bookbinding apparatus according to claim 8, wherein each near the one corner of the spine and near the another corner of spine is a position 0-15 mm inside from each corner.

10. The bookbinding apparatus according to claim 8, wherein the predetermined duration is not less than 0.5 second and not more than an open time of the adhesives.

11. The bookbinding apparatus according to claim 8, wherein the control device controls the first moving device to move the coating device from near the one corner to near the another corner along the spine based on setup sheet size information.

12. The bookbinding apparatus according to claim 8, wherein the control device controls the first moving device to move coating device until near the another corner of the spine of the sheet bundle after the predetermined duration of the stop of the coating device, and then the control device controls the second moving device to move coating device toward the spine of the sheet bundle and makes the first moving device to make the coating device to move to near the one corner from near the another corner along the spine.

13. The bookbinding apparatus according to claim 8, wherein, the control device controls the second moving device to move the coating device towards the spine of the sheet bundle after the predetermined duration of the stop of the coating device, and then controls the first moving device to move the coating device to near the one corner from near the another corner along the spine.

14. The bookbinding apparatus according to claim 8, wherein the control device controls the second moving device to move the coating device towards the spine of the sheet bundle in the case when the coating device moves from near the one corner to near the another corner and in the case when the coating device moves from near the another corner to near the one corner, or when the coating device moves from near the one corner to near the another corner.

15. An image forming system comprising an image forming apparatus for forming image on a sheet and the bookbinding apparatus according to claim 8 which binds sheet on which an image has been formed by the image forming apparatus into a booklet.
